(19) United States
(12) Patent Application Publication
(10) Pub. No.: US 2025/0362546 A1
(43) Pub. Date: Nov. 27, 2025

(54) DISPLAY DEVICE

(71) Applicant: HannStar Display Corporation, Taipei City (TW)

(72) Inventors: Chen-Hao Su, Taipei City (TW); Cheng-Yen Yeh, Taipei City (TW); Yu-Cheng Lin, Taipei City (TW); Mu-Kai Kang, Taipei City (TW); Ting Wei Liu, Taipei City (TW); Chia-Yu Liu, Taipei City (TW); Heng-I Chang, Taipei City (TW); Shu Chan Hsiao, Taipei City (TW)

(73) Assignee: HannStar Display Corporation, Taipei City (TW)

(21) Appl. No.: 18/963,812

(22) Filed: Nov. 29, 2024

(30) Foreign Application Priority Data
May 24, 2024 (CN) 202410655242.8

(51) Int. Cl. G02F 1/13363; G02F 1/1335; G02F 1/1362

(52) U.S. Cl. CPC G02F 1/13363; G02F 1/133528; G02F 1/133553; G02F 1/133616; G02F 1/136222; G02F 2202/28

(57) ABSTRACT

A display device includes a pixel array substrate, a color filter substrate, a liquid crystal layer, a polarizing layer, and a compensation film. The color filter substrate is disposed to overlap the pixel array substrate. The liquid crystal layer is disposed between the pixel array substrate and the color filter substrate, and has a liquid crystal optical axis. The polarizing layer is disposed on the color filter substrate, and has an absorption axis. The compensation film is disposed between the polarizing layer and the liquid crystal layer, and has a compensation film optical axis. A first included angle between the liquid crystal optical axis and the compensation film optical axis is within a range between 62.5 degrees to 65 degrees. A second included angle between the absorption axis and the liquid crystal optical axis is within a range between 80 degrees to 85 degrees or 5 degrees to 10 degrees.

### CROSS-REFERENCE TO RELATED APPLICATION

This application claims the priority benefit of China application serial no. 202410655242.8, filed on May 24, 2024. The entirety of the above-mentioned patent application is hereby incorporated by reference herein and made a part of this specification.

### BACKGROUND

### Technical Field

The disclosure relates to a display device, and particularly relates to a display device with a compensation film.

### Description of Related Art

Most reflective LCDs face a problem of grayscale inversion. A main reason thereof includes a driving method of a liquid crystal layer, such as driving in a twisted nematic (TN) mode. In addition, a chromaticity performance of the reflective LCD in a dark state is easily affected significantly by a thickness variation of the liquid crystal layer.

### SUMMARY

The disclosure is directed to a display device, which has a low color difference in a dark state and has better mass production performance.

According to an embodiment of the disclosure, the display device includes a pixel array substrate, a color filter substrate, a liquid crystal layer, a polarizing layer, and a compensation film. The color filter substrate is disposed to overlap the pixel array substrate. The liquid crystal layer is disposed between the pixel array substrate and the color filter substrate, and has a liquid crystal optical axis. The polarizing layer is disposed on the color filter substrate, and has an absorption axis. The compensation film is disposed between the polarizing layer and the liquid crystal layer, and has a compensation film optical axis. A first included angle between the liquid crystal optical axis and the compensation film optical axis is within a range between 62.5 degrees to 65 degrees. A second included angle between the absorption axis and the liquid crystal optical axis is within a range between 80 degrees to 85 degrees or 5 degrees to 10 degrees.

In the display device according to the embodiment of the disclosure, a third included angle between the absorption axis of the polarizing layer and the compensation film optical axis is within a range between 17.5 degrees to 22.5 degrees.

In the display device according to the embodiment of the disclosure, the first included angle is 63.5 degrees, the second included angle is 82 degrees, and the third included angle is 18.5 degrees.

In the display device according to the embodiment of the disclosure, the first included angle is 65 degrees, the second included angle is 85 degrees, and the third included angle is 20 degrees.

In the display device according to the embodiment of the disclosure, the first included angle is 62.5 degrees, the second included angle is 80 degrees, and the third included angle is 17.5 degrees.

In the display device according to the embodiment of the disclosure, the third included angle between the absorption axis of the polarizing layer and the compensation film optical axis is within a range between 67.5 degrees to 72.5 degrees.

In the display device according to the embodiment of the disclosure, the third included angle is 71.5 degrees.

In the display device according to the embodiment of the disclosure, the first included angle is 63.5 degrees, and the second included angle is 82 degrees.

In the display device according to the embodiment of the disclosure, the first included angle is 63.5 degrees, and the second included angle is 8 degrees.

In the display device according to the embodiment of the disclosure, the compensation film is a half wave plate.

In the display device according to the embodiment of the disclosure, the display device further includes a front light module, which is disposed on a side of the color filter substrate facing away from the liquid crystal layer, and includes a light guide plate and a light source. The light guide plate has a light incident surface and a light-emitting surface connected to each other. The light-emitting surface faces the color filter substrate. The light source is disposed on a side of the light incident surface of the light guide plate.

In the display device according to the embodiment of the disclosure, the display device further includes an electrode layer disposed on the pixel array substrate, and the electrode layer is a reflective electrode layer.

In the display device according to the embodiment of the disclosure, the display device further includes an electrode layer and a reflective layer. The electrode layer is disposed on the pixel array substrate. The reflective layer is disposed between the electrode layer and the pixel array substrate. The display device has a reflective area and a transmissive area outside the reflective area. The reflective layer defines the reflective area, and the electrode layer overlaps the reflective area and the transmissive area.

In the display device according to the embodiment of the disclosure, the display device further includes an adhesive layer disposed between the compensation film and the color filter substrate.

In the display device according to the embodiment of the disclosure, the adhesive layer is a diffusion adhesive layer.

Based on the above description, in the display device of an embodiment of the disclosure, when the liquid crystal layer disposed between the pixel array substrate and the color filter substrate is in the dark state, the liquid crystal optical axis thereof is arranged horizontally. Regarding the polarizing layer disposed on the color filter substrate, an included angle between its absorption axis and the liquid crystal optical axis is within a range between 80 degrees to 85 degrees or 5 degrees to 10 degrees. Regarding the compensation film disposed between the polarizing layer and the liquid crystal layer, an included angle between its compensation film optical axis and the liquid crystal optical axis is within a range between 62.5 degrees to 65 degrees. Therefore, in addition to effectively improving the chromaticity performance of the display device in the dark state, a dark state color difference phenomenon of the display device caused by variation of a film thickness of the liquid crystal layer may also be mitigated.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B depict cross-sectional views of a display device respectively operating under a dark state and a bright state according to a first embodiment of the disclosure.

FIG. 2A is a schematic diagram of an axial relationship between a liquid crystal optical axis, a compensation film optical axis, and an absorption axis in the display device of FIG. 1A.

FIG. 2B to FIG. 2D are schematic diagrams of other modified implementations of FIG. 2A.

FIG. 3A is a diagram showing a chromaticity performance of the display device of FIG. 1A when a third included angle between a compensation film optical axis and an absorption axis is 18.5 degrees and at different film thicknesses of a liquid crystal layer.

FIG. 3B is a diagram showing a chromaticity performance of the display device of FIG. 1A when the third included angle between the compensation film optical axis and the absorption axis is 17.5 degrees and at different film thicknesses of the liquid crystal layer.

FIG. 3C is a diagram showing a chromaticity performance of the display device of FIG. 1A when the third included angle between the compensation film optical axis and the absorption axis is 20 degrees and at different film thicknesses of the liquid crystal layer.

FIG. 3D is a diagram showing a chromaticity performance of the display device of FIG. 1A when the third included angle between the compensation film optical axis and the absorption axis is 22.5 degrees and at different film thicknesses of the liquid crystal layer.

FIG. 4 depicts a cross-sectional view of a display device operating under a dark state according to a second embodiment of the disclosure.

FIG. 5A and FIG. 5B depict cross-sectional views of a display device operating under a dark state and a bright state respectively according to a third embodiment of the disclosure.

FIG. 6A and FIG. 6B depict cross-sectional views of a display device operating under a dark state and a bright state according to a fourth embodiment of the disclosure.

FIG. 7A is a schematic diagram of an axial relationship between a liquid crystal optical axis, a compensation film optical axis, and an absorption axis in the display device of FIG. 6A.

FIG. 7B to FIG. 7D are schematic diagrams of other modified implementations of FIG. 7A.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

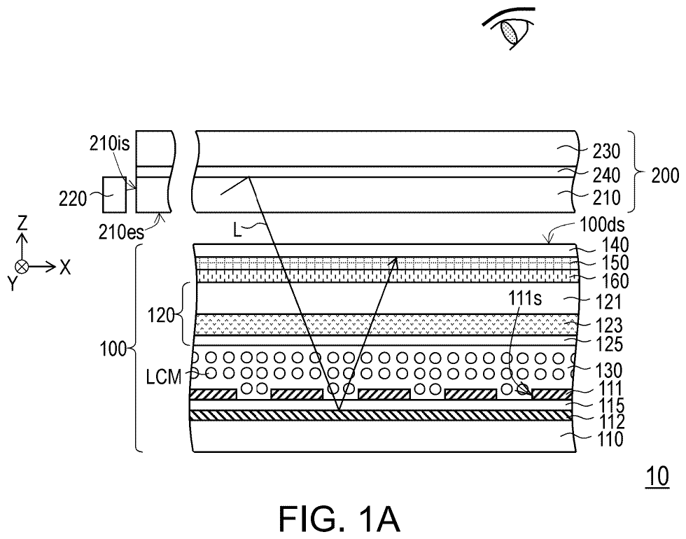

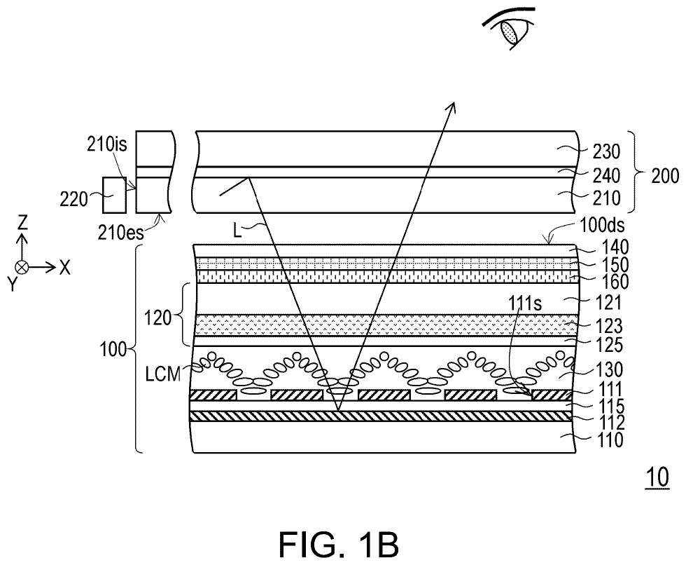

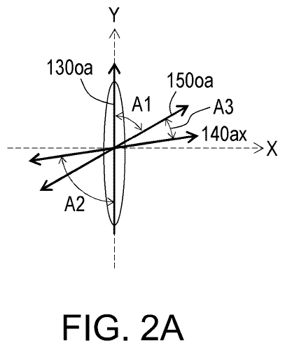

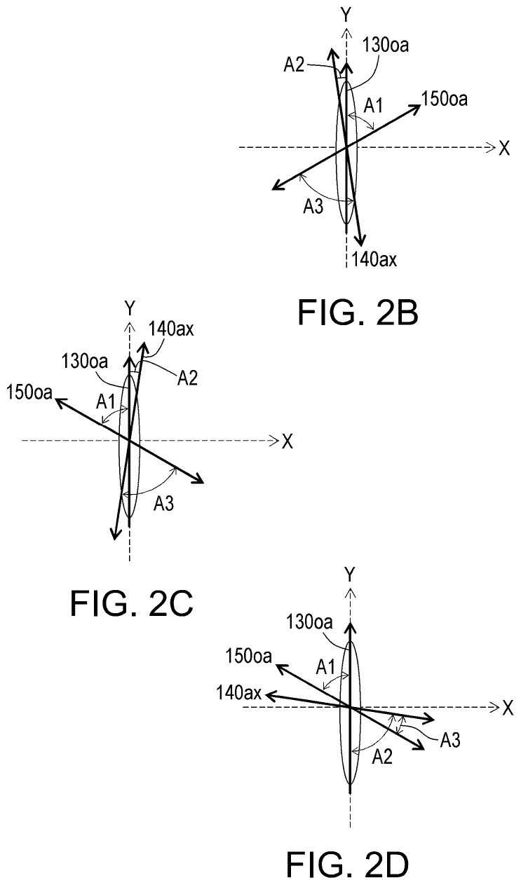

FIG. 1A and FIG. 1B depict cross-sectional views of a display device respectively operating under a dark state and a bright state according to a first embodiment of the disclosure. FIG. 2A is a schematic diagram of an axial relationship between a liquid crystal optical axis, a compensation film optical axis, and an absorption axis in the display device of FIG. 1A. FIG. 2B to FIG. 2D are schematic diagrams of other modified implementations of FIG. 2A.

In FIG. 1A and FIG. 2A, a display device 10 includes a display panel 100 having a display surface 100ds. The display panel 100 includes a pixel array substrate 110, a color filter substrate 120, and a liquid crystal layer 130. The color filter substrate 120 overlaps the pixel array substrate 110. The pixel array substrate 110 includes, for example, a plurality of data lines, a plurality of scan lines, and a plurality of active elements that are not shown, where each active element may be electrically connected to a data line and a scan line, but the disclosure is not limited thereto. The liquid crystal layer 130 is disposed between the pixel array substrate 110 and the color filter substrate 120 and has a liquid crystal optical axis 1300a. In the embodiment, the display panel 100 is, for example, a reflective liquid crystal display panel.

In order to meet the use requirements of the display device 10 in a dim environment, the display device 10 may further include a front light module 200, which is disposed on one side of the display surface 100ds of the display panel 100. More specifically, the front light module 200 is disposed on a side of the color filter substrate 120 facing away from the liquid crystal layer 130. The front light module 200 may include a light guide plate 210, a light source 220, a cover plate 230, and an adhesive layer 240, but the disclosure is not limited thereto. For example, the front light module 200 may further include a microstructure layer (not shown), or microstructures may be formed on the light guide plate to achieve a desired optical effect. The light guide plate 210 has a light incident surface 210is and a light-emitting surface 210es connected to each other, where the light-emitting surface 210es faces the color filter substrate 120. The light source 220 is disposed on a side of the light incident surface 210is of the light guide plate 210, and is adapted to emit light L. After the light L passes through the light incident surface 210is and is horizontally transmitted inside the light guide plate 210, the light L passes through the light-emitting surface 210es and irradiates the display panel 100.

The front light module 200 herein is, for example, the side light type light source of FIG. 1A or 1B, but the disclosure is not limited thereto. Another feasible front light structure may also be designed as a front light structure of a surface light source to achieve the desired optical display effect.

In the embodiment, the pixel array substrate 110 may be provided with an electrode layer 111, an electrode layer 112, and a passivation layer 115. The passivation layer 115 is disposed between the electrode layer 111 and the electrode layer 112 to make the two electrode layers electrically independent from each other. The electrode layer 112 is disposed between the electrode layer 111 and the pixel array substrate 110. For example, the electrode layer 112 of the embodiment may be a reflective electrode layer, which is adapted to reflect light (such as ambient light or light L emitted by the front light module 200) incident on the display panel 100 from the side of the display surface 100ds. It is particularly noted that one of the electrode layer 111 and the electrode layer 112 may be electrically connected to an active element (not shown) of the pixel array substrate 110.

The electrode layer 111 may have a plurality of micro-slits 111s, and the micro-slits 111s overlap the electrode layer 112 along a normal direction (for example, a direction Z) of the display surface 100ds. Fringing electric field generated by the two electrode layers through the micro-slits 111s may drive a plurality of liquid crystal molecules LCM of the liquid crystal layer 130 to rotate substantially along a horizontal plane (for example, an XY plane). In other words, the liquid crystal layer 130 of the embodiment is driven in a fringe-field switching (FFS) mode, but the disclosure is not limited thereto.

On the other hand, the color filter substrate 120 may include a substrate 121 and a color filter layer 123 and a cover layer 125 sequentially disposed on the substrate 121, but the disclosure is not limited thereto. In the embodiment, the liquid crystal molecules LCM of the liquid crystal layer 130 are, for example, arranged along a direction Y (as shown in FIG. 1A) when no external force (such as an electric field) is applied. Namely, the liquid crystal optical axis 130oa of the liquid crystal layer 130 is parallel to the direction Y in a natural state. The plurality of micro-slits 111s of the electrode layer 111 are, for example, arranged at intervals along the direction X, and the fringing electric field generated by the micro-slits 111s and the electrode layer 112 is substantially distributed along an XZ plane.

In the embodiment, a material of the liquid crystal layer 130 is, for example, positive liquid crystal. Therefore, when the liquid crystal molecules LCM are subjected to a function of the fringing electric field, their molecular long axes tend to deviate from the direction Y and a deflection angle increases as they approach the micro-slits 111s (as shown in FIG. 1B).

In order to achieve a display effect, the display panel 100 further includes a polarizing layer 140. The polarizing layer 140 is disposed on the color filter substrate 120 and has an absorption axis 140ax. It is particularly noted that a compensation film 150 is further disposed between the polarizing layer 140 and the color filter substrate 120. The compensation film 150 is, for example, a half-wave plate, but the disclosure is not limited thereto. The polarizing layer 140 and the compensation film 150 may be attached to a side surface of the color filter substrate 120 facing away from the liquid crystal layer 130 via an adhesive layer 160. Namely, the adhesive layer 160 is disposed between the compensation film 150 and the color filter substrate 120. In the embodiment, the adhesive layer 160 is, for example, a diffusion adhesive layer, but the disclosure is not limited thereto.

For example, in the embodiment, when the electrode layer 111 and the electrode layer 112 are not enabled, the liquid crystal optical axis 130oa of the liquid crystal layer 130 is horizontally arranged along the direction Y. After the light L is reflected by the electrode layer 112 and passes through the liquid crystal layer 130 and the compensation film 150 twice, a polarization direction of an electric field thereof is parallel to the absorption axis 140ax of the polarizing layer 140, so that the reflected light L cannot pass through the polarizing layer 140 again (as shown in FIG. 1A). At this time, the display device 10 is operated under a dark state.

On the contrary, when the electrode layer 111 and the electrode layer 112 are enabled, the fringing electric field formed between the two electrode layers may drive molecular long axes of the liquid crystal molecules LCM of the liquid crystal layer 130 to tend to rotate away from the direction Y. After the light is reflected by the electrode layer 112 and passes through the liquid crystal layer 130 and the compensation film 150 twice, the polarization direction of the electric field thereof may be perpendicular to the absorption axis 140ax of the polarizing layer 140, so that the reflected light L may be emitted through the polarizing layer 140 again (as shown in FIG. 1B). At this time, the display device 10 is operated under a bright state.

In the disclosure, a first included angle A1 between the compensation film optical axis 150oa of the compensation film 150 and the liquid crystal optical axis 130oa is preferably within a range between 62.5 degrees to 65 degrees. A second included angle A2 between the absorption axis 140ax of the polarizing layer 140 and the liquid crystal optical axis 130oa is preferably within a range between 80 degrees to 85 degrees or 5 degrees to 10 degrees. A third included angle A3 between the absorption axis 140ax and the compensation film optical axis 150oa is preferably within a range between 17.5 degrees to 22.5 degrees. The aforementioned compensation film optical axis 150oa may be a fast axis or slow axis of the compensation film 150.

First, it is explained that through the aforementioned configuration relationship of the liquid crystal optical axis 1300a, the absorption axis 140ax and the compensation film optical axis 150oa, not only the chromaticity performance of the display device 10 in the dark state is effectively improved, but also the dark state color difference phenomenon of the display device 10 caused by variation of the film thickness of the liquid crystal layer 130 may be mitigated.

For example, in the embodiment, the first included angle A1 between the compensation film optical axis 1500a and the liquid crystal optical axis 1300a is 63.5 degrees, the second included angle A2 between the absorption axis 140ax and the liquid crystal optical axis 130oa is 82 degrees, and the third included angle A3 between the absorption axis 140ax and the compensation film optical axis 1500a is 18.5 degrees (as shown in FIG. 2A). From another point of view, an included angle between the absorption axis 140ax of the polarizing layer 140 and the direction X is 8 degrees, and an included angle between the compensation film optical axis 1500a of the compensation film 150 and the direction X is 26.5 degrees.

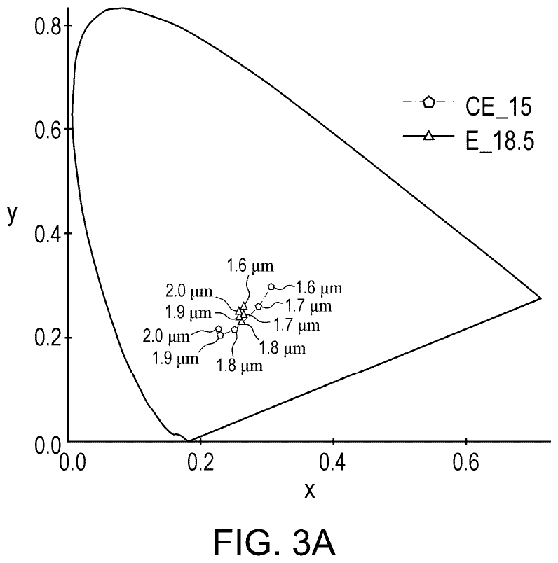

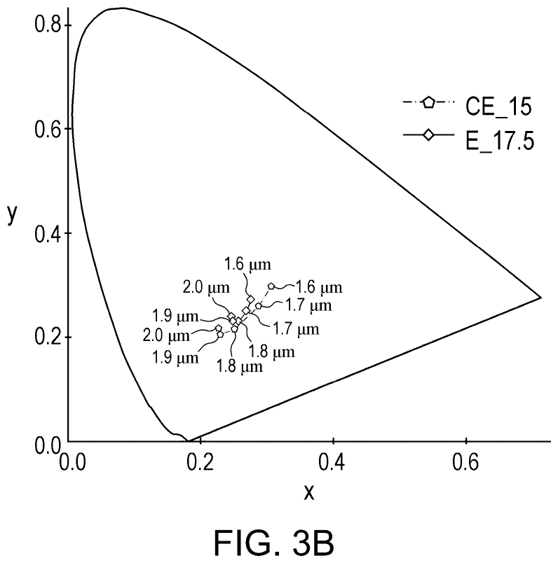

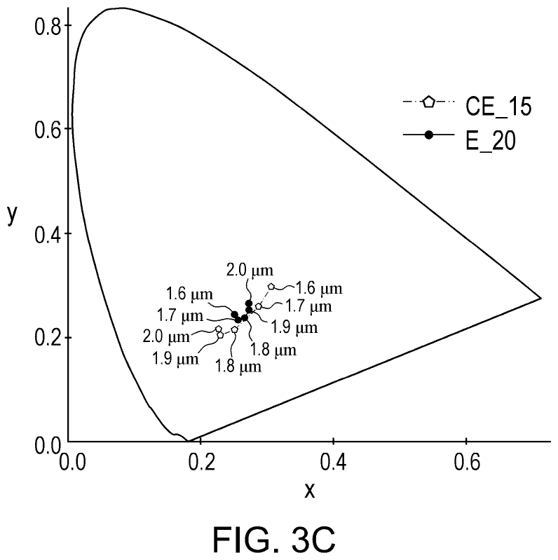

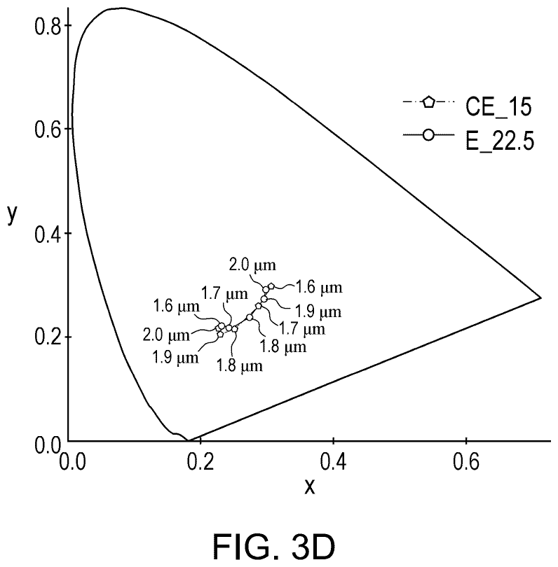

FIG. 3A is a diagram showing a chromaticity performance of the display device of FIG. 1A when the third included angle A3 between the compensation film optical axis and the absorption axis is 18.5 degrees and at different film thicknesses of the liquid crystal layer. The chromaticity performance here is presented, for example, by a distribution of chromaticity coordinates (x, y) in the CIE 1931 color space. Where, a distribution E_18.5 shows that when the display device 10 of FIG. 1A is configured with the angle relationship of FIG. 2A, its chromaticity performance in the dark state corresponds to changes of five thicknesses of the liquid crystal layer 130. The aforementioned five thicknesses are 1.6 μm, 1.7 μm, 1.8 μm, 1.9 μm and 2.0 μm, respectively. FIG. 3A also shows a distribution CE_15 as a comparative example, in which the first included angle A1 between the compensation film optical axis and the liquid crystal optical axis is 60 degrees, the second included angle A2 between the absorption axis and the liquid crystal optical axis is 75 degrees, and the third included angle A3 between the absorption axis and the compensation film optical axis is 15 degrees.

From FIG. 3A, comparing with the chromaticity variation of the comparative example at different liquid crystal layer thicknesses (i.e., the distribution CE_15), under the angle configuration relationship of FIG. 2A of the display device 10 of the embodiment, the difference in dark state chromaticity thereof at different thicknesses of the liquid crystal layer 130 may be effectively reduced.

However, the disclosure is not limited thereto. In some other modified implementations, the first included angle A1 between the compensation film optical axis 150oa and the liquid crystal optical axis 130oa is 63.5 degrees, the second included angle A2 between the absorption axis 140ax and the liquid crystal optical axis 1300a is 8 degrees, and the third included angle A3 between the absorption axis 140ax and the compensation film optical axis 150oa is 71.5 degrees (as shown in FIG. 2B). Alternatively, the first included angle A1 between the compensation film optical axis 1500a and the liquid crystal optical axis 130oa is 63.5 degrees, the second included angle A2 between the absorption axis 140ax and the liquid crystal optical axis 130oa is 8 degrees, and the third included angle A3 between the absorption axis 140ax and the compensation film optical axis 1500a is 71.5 degrees (as shown in FIG. 2C). Alternatively, the first included angle A1 between the compensation film optical axis 1500a and the liquid crystal optical axis 130oa is 63.5 degrees, the second included angle A2 between the absorption axis 140ax and the liquid crystal optical axis 1300a is 82 degrees, and the third included angle A3 between the absorption axis 140ax and the compensation film optical axis 1500a is 18.5 degrees (as shown in FIG. 2D). The technical effects of the angle configuration relationships in these modified implementations in the display device 10 (i.e., the difference in dark state chromaticity under different film thicknesses of the liquid crystal layer 130 may be effectively reduced) are equivalent to the angle configuration relationship of FIG. 2A.

Further, in the embodiment, the third included angle A3 between the compensation film optical axis 1500a and the absorption axis 140ax of the display device 10 may be any angle within a range between 17.5 to 22.5 degrees in addition to 18.5 degrees. For example, FIG. 3B to FIG. 3D are diagrams showing chromaticity performances of the display device 10 of FIG. 1A when the third included angle A3 between the compensation film optical axis 1500a and the absorption axis 140ax is 17.5 degrees, 20 degrees, and 22.5 degrees, respectively, and at different film thicknesses of the liquid crystal layer. The chromaticity performance here is presented, for example, by the distribution of chromaticity coordinates (x, y) in the CIE 1931 color space.

In FIG. 3B, the distribution E_17.5 shows that when the display device 10 of FIG. 1A is configured with the angle relationship similar to that FIG. 2A but the third included angle is 17.5 degrees, its chromaticity performance in the dark state corresponds to changes of five thicknesses of the liquid crystal layer 130, and the five thicknesses are 1.6 μm, 1.7 μm, 1.8 μm, 1.9 μm and 2.0 μm, respectively. In the embodiment, the first included angle A1 between the compensation film optical axis 1500a and the liquid crystal optical axis 130oa is 62.5 degrees, and the second included angle A2 between the absorption axis 140ax and the liquid crystal optical axis 130oa is 80 degrees. From another point of view, the included angle between the absorption axis 140ax of the polarizing layer 140 and the direction X is 10 degrees, and the included angle between the compensation film optical axis 150oa of the compensation film 150 and the direction X is 27.5 degrees.

From FIG. 3B, comparing with the chromaticity variation of the comparative example at different thicknesses of the liquid crystal layer (i.e., the distribution CE_15), under the configuration of the display device 10 of the embodiment with the third included angle A3 at 17.5 degrees, the difference of dark state chromaticity under different film thicknesses of the liquid crystal layer 130 may be effectively reduced.

In FIG. 3C, a distribution E_20 shows that when the display device 10 of FIG. 1A is configured with the angle relationship similar to that of FIG. 2A but the third included angle A3 is 20 degrees, its chromaticity performance in the dark state corresponds to changes of five thicknesses of the liquid crystal layer 130, and the five thicknesses are 1.6 μm, 1.7 μm, 1.8 μm, 1.9 μm and 2.0 μm, respectively. In the embodiment, the first included angle A1 between the compensation film optical axis 150oa and the liquid crystal optical axis 130oa is 65 degrees, and the second included angle A2 between the absorption axis 140ax and the liquid crystal optical axis 130oa is 85 degrees. From another point of view, the included angle between the absorption axis 140ax of the polarizing layer 140 and the direction X is 5 degrees, and the included angle between the compensation film optical axis 150oa of the compensation film 150 and the direction X is 25 degrees.

From FIG. 3C, comparing with the chromaticity variation of the comparative example at different thicknesses of the liquid crystal layer (i.e., the distribution CE_15), under the configuration of the display device 10 of the embodiment with the third included angle A3 at 20 degrees, the difference of dark state chromaticity under different film thicknesses of the liquid crystal layer 130 may be effectively reduced.

In FIG. 3D, a distribution E_22.5 shows that when the display device 10 of FIG. 1A is configured with the angle relationship similar to that of FIG. 2A but the third included angle A3 is 22.5 degrees, its chromaticity performance in the dark state corresponds to changes of five thicknesses of the liquid crystal layer 130, and the five thicknesses are 1.6 μm, 1.7 μm, 1.8 μm, 1.9 μm and 2.0 μm, respectively. In the embodiment, the first included angle A1 between the compensation film optical axis 150oa and the liquid crystal optical axis 130oa is 67.5 degrees, and the second included angle A2 between the absorption axis 140ax and the liquid crystal optical axis 130oa is 90 degrees. From another point of view, the included angle between the absorption axis 140ax of the polarizing layer 140 and the direction X is 0 degree, and the included angle between the compensation film optical axis 1500a of the compensation film 150 and the direction X is 22.5 degrees.

From FIG. 3D, comparing with the chromaticity variation of the comparative example at different thicknesses of the liquid crystal layer (i.e., the distribution CE_15), under the configuration of the display device 10 of the embodiment with the third included angle A3 at 22.5 degrees, the difference of dark state chromaticity under different film thicknesses of the liquid crystal layer 130 may be effectively reduced.

Other embodiments will be listed below to explain the disclosure in detail, where the same reference numbers denote the same or like components, and descriptions of the same technical contents are omitted. The aforementioned embodiment may be referred for descriptions of the omitted parts, and detailed descriptions thereof are not repeated in the following embodiment.

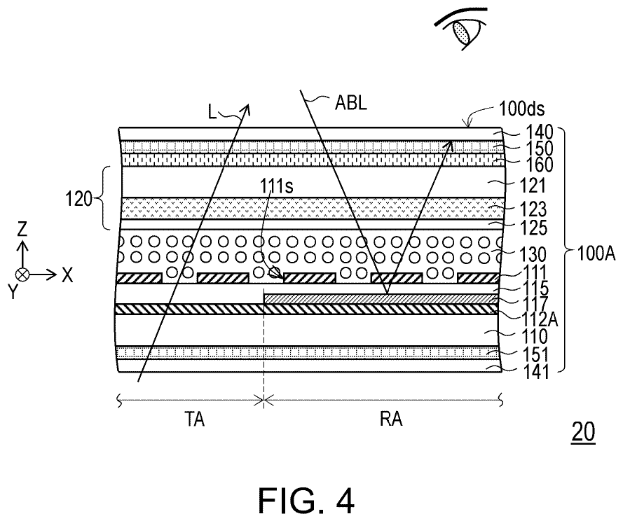

FIG. 4 depicts a cross-sectional view of a display device operating under a dark state according to a second embodiment of the disclosure. Referring to FIG. 4, a main difference between a display device 20 of the embodiment and the display device 10 of FIG. 1A lies in different types of the display panel. For example, in the embodiment, the display panel 100A is, for example, a transflective liquid crystal display panel.

In detail, the display device 20 may be provided with a reflective area RA and a transmissive area TA outside the reflective area RA. In the embodiment, the electrode layer 112A may be a light-transmissive electrode layer, and the display panel 100A may further be provided with a reflective layer 117 between the electrode layer 111 and the pixel array substrate 110. The reflective layer 117 may define the reflective area RA of the display device 20, and is suitable for reflecting ambient light ABL from the side of the polarizing layer 140. The transmissive area TA of the display device 20 is suitable for allowing light L (such as ambient light or illumination light emitted by a backlight source) from a back side of the display device 20 (i.e., the bottom of FIG. 4) to pass through. It is particularly noted that the electrode layer 111 and the electrode layer 112A respectively overlap the reflective area RA and the transmissive area TA. Namely, the liquid crystal layer 130 of the display device 20 may simultaneously modulate a phase delay of the light L passing through the transmissive area TA and the ambient light ABL incident on the reflective area RA. In order to meet dimming requirements in the transmissive area TA, the display device 20 may further include another polarizing layer 141 and another compensation film 151 disposed on a side surface of the pixel array substrate 110 facing away from the liquid crystal layer 130.

Since the angle configuration relationship between the absorption axis of the polarizing layer 140, the compensation film optical axis of the compensation film 150, and the liquid crystal optical axis of the liquid crystal layer 130 of the embodiment is similar to that of the display device of FIG. 1A, please refer to the relevant paragraphs of the aforementioned embodiment for detailed description, which will not be repeated here. In the embodiment, the display device 20 may not be provided with the front light module 200 as shown in FIG. 1A.

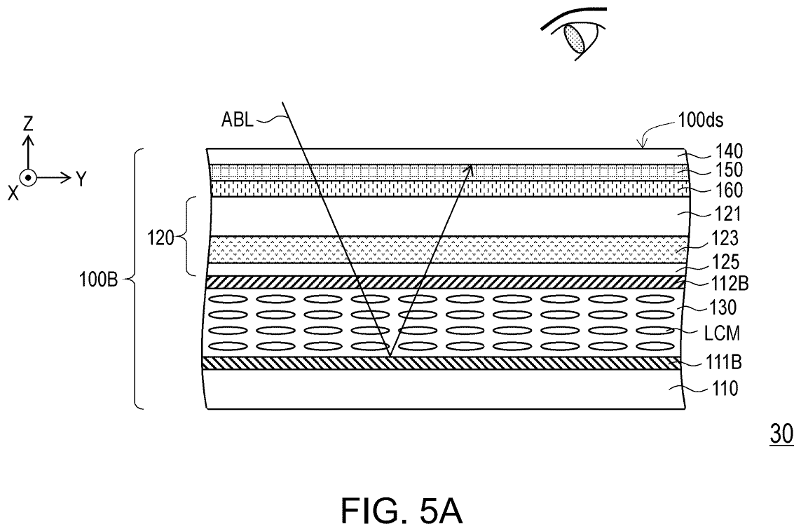

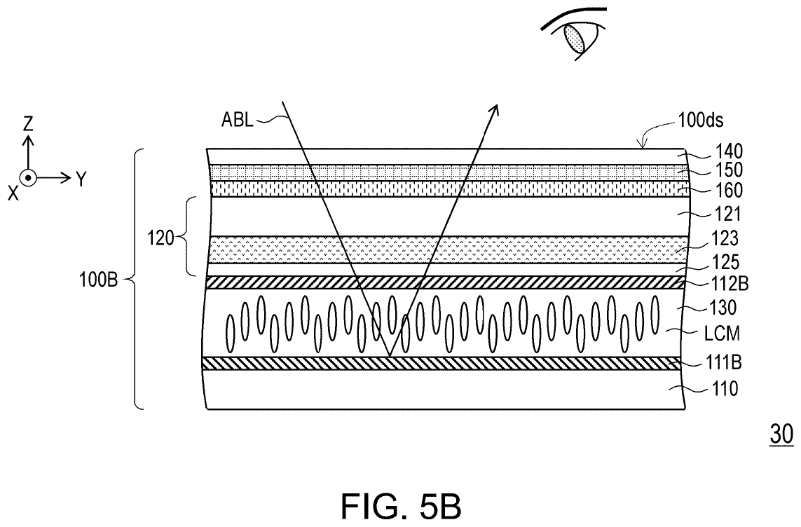

FIG. 5A and FIG. 5B depict cross-sectional views of a display device operating under a dark state and a bright state respectively according to a third embodiment of the disclosure. Referring to FIG. 5A and FIG. 5B, a main difference between a display device 30 of the embodiment and the display device 10 of FIG. 1A lies in different driving methods of the liquid crystal layer. For example, in the embodiment, the liquid crystal layer 130 of the display panel 100B is, for example, driven in an electrically controlled birefringence (ECB) mode. In detail, an electrode layer 111B and an electrode layer 112B are respectively provided on the pixel array substrate 110 and the color filter substrate 120, where the electrode layer 111B is a reflective electrode layer.

Similar to the liquid crystal layer 130 of FIG. 1A, when the liquid crystal layer 130 of the embodiment is in the natural state (i.e., not subject to external forces), the liquid crystal optical axis thereof is also arranged along the direction Y. At this time, after the ambient light ABL is reflected by the electrode layer 111B and passes through the liquid crystal layer 130 and the compensation film 150 twice, a polarization direction of its electric field may be parallel to the absorption axis of the polarizing layer 140, so that the reflected ambient light ABL cannot pass through the polarizing layer 140 again (as shown in FIG. 5A). At this time, the display device 30 is operated under the dark state.

In the embodiment, a material of the liquid crystal layer 130 is, for example, positive liquid crystal. When the liquid crystal molecules LCM of the liquid crystal layer 130 are functioned by a vertical electric field formed between the electrode layer 111B and the electrode layer 112B, molecular long axes of the liquid crystal molecules LCM tend to deviate from the direction Y and rotate along the YZ plane. For example, when the electric field is large enough, an axial direction of the molecular long axes of the liquid crystal molecules LCM may be substantially parallel to the direction Z. At this time, after the ambient light ABL is reflected by the electrode layer 111B and passes through the liquid crystal layer 130 and the compensation film 150 twice, the polarization direction of the electric field thereof may be perpendicular to the absorption axis of the polarizing layer 140, so that the reflected ambient light ABL may pass through the polarizing layer 140 again for emission (as shown in FIG. 5B). At this time, the display device 30 is operated under the bright state.

Since the axial configuration relationship of the liquid crystal optical axis of the liquid crystal layer 130 of the display device 30, the absorption axis of the polarizing layer 140 and the compensation film optical axis of the compensation film 150 and the technical effects that they play in the display device 30 are all similar to those of the display device 10 of FIG. 1A, please refer to the relevant paragraphs of the aforementioned embodiments for detailed description, which will not be repeated here.

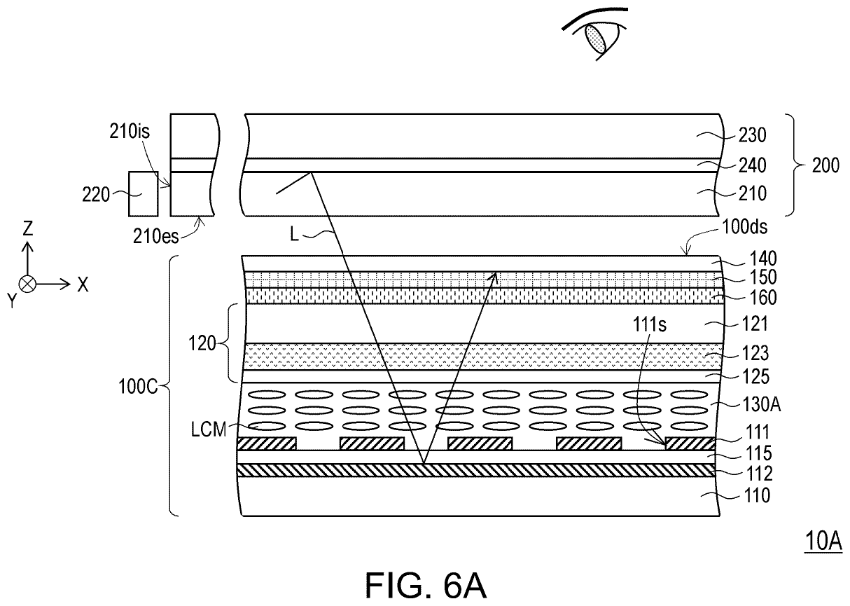

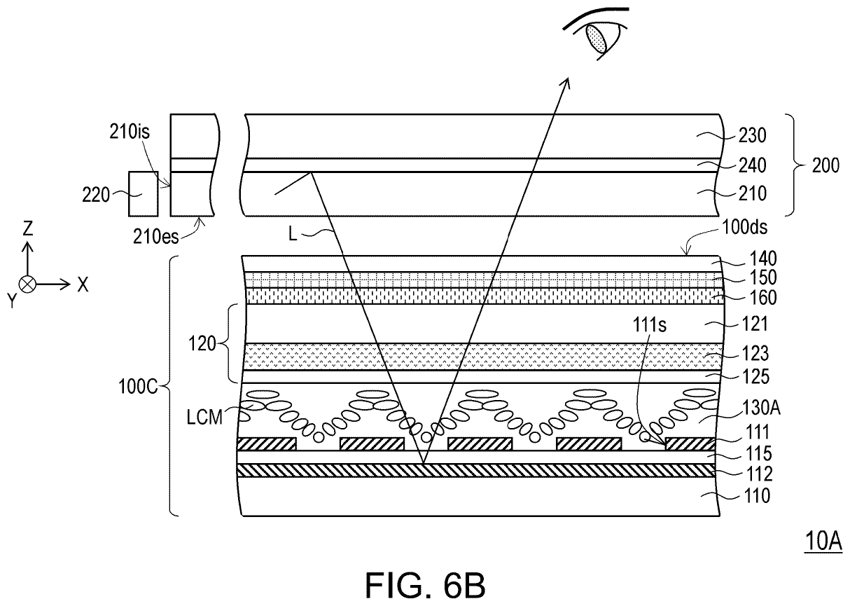

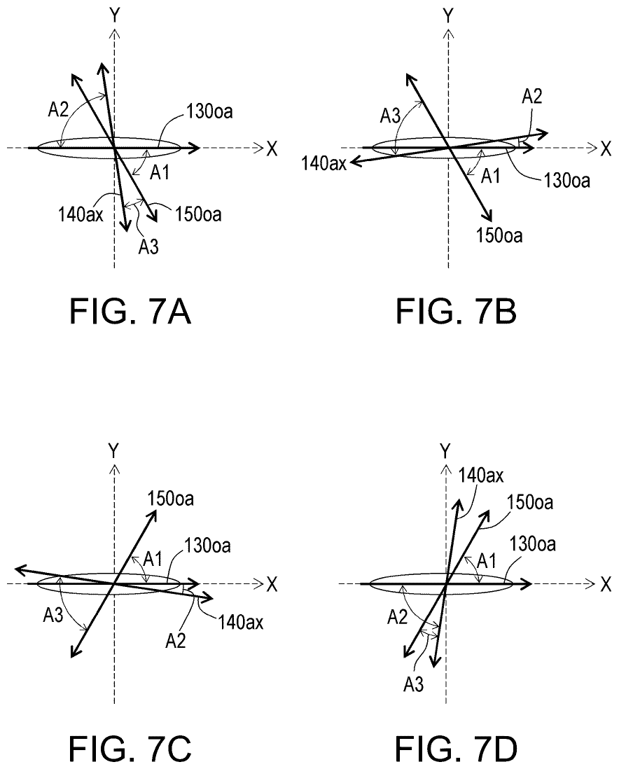

FIG. 6A and FIG. 6B depict cross-sectional views of a display device operating under a dark state and a bright state according to a fourth embodiment of the disclosure. FIG. 7A is a schematic diagram of an axial relationship between a liquid crystal optical axis, a compensation film optical axis, and an absorption axis in the display device of FIG. 6A. FIG. 7B to FIG. 7D are schematic diagrams of other modified implementations of FIG. 7A.

Referring to FIG. 6A, FIG. 6B and FIG. 7A, a difference between a display device 10A of the embodiment and the display device 10 of FIG. 1A lies in different types of the liquid crystal layer. Specifically, in the embodiment, a material of a liquid crystal layer 130A of a display panel 100C is, for example, negative liquid crystal, and the liquid crystal optical axis 130oa of the liquid crystal layer 130A is arranged along the direction X.

For example, in the embodiment, when the electrode layer 111 and the electrode layer 112 are not enabled, the liquid crystal optical axis 130oa of the liquid crystal layer 130A is arranged horizontally along the direction Y. At this time, after the light L is reflected by the electrode layer 112 and passes through the liquid crystal layer 130 and the compensation film 150 twice, the polarization direction of the electric field thereof is parallel to the absorption axis 140ax of the polarizing layer 140, so that the reflected light L cannot pass through the polarizing layer 140 again (as shown in FIG. 6A). At this time, the display device 10A is operated under the dark state.

On the contrary, when the electrode layer 111 and the electrode layer 112 are enabled, the fringing electric field formed between the two electrode layers may drive the molecular long axes of the liquid crystal molecules LCM of the liquid crystal layer 130A to tend to rotate away from the direction X, and a deflection angle may increase as they approach the micro-slits 111s. At this time, after the light L is reflected by the electrode layer 112 and passes through the liquid crystal layer 130A and the compensation film 150 twice, the polarization direction of the electric field thereof may be perpendicular to the absorption axis 140ax of the polarizing layer 140, so that the reflected light L may be emitted through the polarizing layer 140 again (as shown in FIG. 6B). At this time, the display device 10A is operating under the bright state.

In the embodiment, the first included angle A1 between the compensation film optical axis 150oa of the compensation film 150 and the liquid crystal optical axis 1300a of the liquid crystal layer 130A is preferably within a range between 62.5 degrees to 65 degrees. The second included angle A2 between the absorption axis 140ax of the polarizing layer 140 and the liquid crystal optical axis 130oa of the liquid crystal layer 130A is preferably within a range between 80 degrees to 85 degrees or 5 degrees to 10 degrees. The third included angle A3 between the absorption axis 140ax and the compensation film optical axis 150oa is preferably within a range between 17.5 degrees to 22.5 degrees.

Through the aforementioned configuration relationship of the liquid crystal optical axis 130oa, the absorption axis 140ax, and the compensation film optical axis 1500a, not only the chromaticity performance of the display device 10A in the dark state can be effectively improved, but also the dark state color difference phenomenon of the display device 10A caused by the variation of the film thickness of the liquid crystal layer 130A may also be mitigated.

For example, in the embodiment, the first included angle A1 between the compensation film optical axis 1500a and the liquid crystal optical axis 1300a is 63.5 degrees, the second included angle A2 between the absorption axis 140ax and the liquid crystal optical axis 1300a is 82 degrees, and the third included angle A3 between the absorption axis 140ax and the compensation film optical axis 150oa is 18.5 degrees (as shown in FIG. 7A). From another point of view, the included angle between the absorption axis 140ax of the polarizing layer 140 and the direction Y is 8 degrees, and the included angle between the compensation film optical axis 1500a of the compensation film 150 and the direction Y is 26.5 degrees.

However, the disclosure is not limited thereto. In other modified implementations, the first included angle A1 between the compensation film optical axis 150oa and the liquid crystal optical axis 130oa is 63.5 degrees, the second included angle A2 between the absorption axis 140ax and the liquid crystal optical axis 130oa is 8 degrees, and the third included angle A3 between the absorption axis 140ax and the compensation film optical axis 1500a is 71.5 degrees (as shown in FIG. 7B). Alternatively, the first included angle A1 between the compensation film optical axis 150oa and the liquid crystal optical axis 130oa is 63.5 degrees, the second included angle A2 between the absorption axis 140ax and the liquid crystal optical axis 130oa is 8 degrees, and the third included angle A3 between the absorption axis 140ax and the compensation film optical axis 150oa is 71.5 degrees (as shown in FIG. 7C). Alternatively, the first included angle A1 between the compensation film optical axis 1500a and the liquid crystal optical axis 130oa is 63.5 degrees, the second included angle A2 between the absorption axis 140ax and the liquid crystal optical axis 130oa is 82 degrees, and the third included angle A3 between the absorption axis 140ax and the compensation film optical axis 1500a is 18.5 degrees (as shown in FIG. 7D). The technical effects (i.e., the variation of dark state chromaticity under different film thicknesses of the liquid crystal layer 130 may be effectively reduced) of the angle configuration relationships in these modified implementations of the display device 10A are equivalent to the angle configuration relationship of FIG. 7A.

In summary, in the display device of an embodiment of the disclosure, when the liquid crystal layer disposed between the pixel array substrate and the color filter substrate is in the dark state, the liquid crystal optical axis thereof is arranged horizontally. Regarding the polarizing layer disposed on the color filter substrate, an included angle between its absorption axis and the liquid crystal optical axis is within a range between 80 degrees to 85 degrees or 5 degrees to 10 degrees. Regarding the compensation film disposed between the polarizing layer and the liquid crystal layer, an included angle between its compensation film optical axis and the liquid crystal optical axis is within a range between 62.5 degrees to 65 degrees. Therefore, in addition to effectively improving the chromaticity performance of the display device in the dark state, a dark state color difference phenomenon of the display device caused by variation of a film thickness of the liquid crystal layer may also be mitigated.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A display device, comprising:
a pixel array substrate;
a color filter substrate, disposed to overlap the pixel array substrate;
a liquid crystal layer, disposed between the pixel array substrate and the color filter substrate, and having a liquid crystal optical axis;
a polarizing layer, disposed on the color filter substrate, and having an absorption axis; and
a compensation film, disposed between the polarizing layer and the liquid crystal layer, and having a compensation film optical axis, wherein a first included angle between the liquid crystal optical axis and the compensation film optical axis is within a range between 62.5 degrees to 65 degrees, a second included angle between the absorption axis and the liquid crystal optical axis is within a range between 80 degrees to 85 degrees or 5 degrees to 10 degrees.

2. The display device as claimed in claim 1, wherein a third included angle between the absorption axis of the polarizing layer and the compensation film optical axis is within a range between 17.5 degrees to 22.5 degrees.

3. The display device as claimed in claim 2, wherein the first included angle is 63.5 degrees, the second included angle is 82 degrees, and the third included angle is 18.5 degrees.

4. The display device as claimed in claim 2, wherein the first included angle is 65 degrees, the second included angle is 85 degrees, and the third included angle is 20 degrees.

5. The display device as claimed in claim 2, wherein the first included angle is 62.5 degrees, the second included angle is 80 degrees, and the third included angle is 17.5 degrees.

6. The display device as claimed in claim 1, wherein a third included angle between the absorption axis of the polarizing layer and the compensation film optical axis is within a range between 67.5 degrees to 72.5 degrees.

7. The display device as claimed in claim 6, wherein the third included angle is 71.5 degrees.

8. The display device as claimed in claim 1, wherein the first included angle is 63.5 degrees, and the second included angle is 82 degrees.

9. The display device as claimed in claim 1, wherein the first included angle is 63.5 degrees, and the second included angle is 8 degrees.

10. The display device as claimed in claim 1, wherein the compensation film is a half wave plate.

11. The display device as claimed in claim 1, further comprising:
a front light module, disposed on a side of the color filter substrate facing away from the liquid crystal layer, and comprising:
a light guide plate, having a light incident surface and a light-emitting surface connected to each other, wherein the light-emitting surface faces the color filter substrate; and
a light source, disposed on a side of the light incident surface of the light guide plate.

12. The display device as claimed in claim 1, further comprising:
an electrode layer, disposed on the pixel array substrate, wherein the electrode layer is a reflective electrode layer.

13. The display device as claimed in claim 1, further comprising:
an electrode layer, disposed on the pixel array substrate; and
a reflective layer, disposed between the electrode layer and the pixel array substrate, wherein the display device has a reflective area and a transmissive area outside the reflective area, the reflective layer defines the reflective area, and the electrode layer overlaps the reflective area and the transmissive area.

14. The display device as claimed in claim 1, further comprising:
an adhesive layer, disposed between the compensation film and the color filter substrate.

15. The display device as claimed in claim 14, wherein the adhesive layer is a diffusion adhesive layer.
